(19) United States
(12) Patent Application Publication
(10) Pub. No.: US 2003/0042731 A1
(43) Pub. Date: Mar. 6, 2003

(54) Voter individually specified and validation number sticker secured ballot and making process

(76) Inventor: Guining Li, Madison, WI (US)

Correspondence Address: GUINING LI, 1445 STARR GRASS DRIVE, MADISON, WI, 53719, US

(21) Appl. No.: 09/943,314

(22) Filed: Aug. 31, 2001

(51) Int. Cl. B42D 15/00

(52) U.S. Cl. 283/5

(57) ABSTRACT

A ballot with characteristics of definite voter intent certainty, extremely high ballot count accuracy, recount and confirmation capability, high accessibility of the aged and the disabled voters, and significant election day wait time reduction, is combined by two parts. The first part is a sheet of paper that is printed with a voter individually specified, computer generated and electronically printed list of voter intent units. Each of the voter intent units comprises one election issue, one chosen candidate for the election issue and one bar code solely representing the election issue and the chosen candidate. The second part is a validation number sticker. A set of validation numbers is generated through a validation number coding method. Each validation number is associated with a bar code. Each validation number and the associated bar code are printed on a sticker. A preferred validation number coding method comprises the steps of generating a set of sequential numbers and associating each number of the set of sequential numbers with a random number. A valid ballot is made by pasting the validation number sticker on a specified place of the paper that is printed with a list of voter intent units. Internet and personal computer resources are utilized for voters to obtain the paper parts of the ballots.

### FIELD OF THE INVENTION

The present invention relates to voting system.

### BACKGROUND OF THE INVENTION

Effort to eliminate all serious problems of current advanced voting systems, which include voter intent certainty, vote count accuracy, vote result confirmation and recount, ballot security, disabled and aged voter accessibility, and voter election day wait time, generated the ground of the present invention.

The current advanced voting systems are mark-sense optical scan voting system and touch-screen voting system. The mark-sense optical scan voting system uses optical scanner to scan ballots that are marked by voters. The marks on multiple choice ballot represent intents of the voters on election issues and are detected by optical scanner. The touch-screen voting system uses touch-screen entry electronic system to record and report intents of voters. These two voting systems show the lowest level of misrepresentation of voter intent among current voting systems. However, these two voting systems also show serious problems. These serious problems are shown in the following issues.

The first issue is voter intent representation. Voter intent representation here includes the aspects of voter intent certainty, vote count accuracy, vote result confirmation, and voting system security.

For the mark-sense optical scan voting system, the major problems in voter intent representation focus on voter intent certainty and vote count accuracy. The marks on the ballot drawn by the voter could cause uncertainty of voter intent and miscount of vote under some circumstances. The judgment for darkness and clearness of the mark is hardly determined by scientifically decisive criteria. The ambiguity in judgment for darkness and clearness of the mark generates the ground for miscount by machine and argument on voter intent by different ballot examiners. Furthermore the opened unmarked space of the ballot makes it possible for the ballot to be altered later without noticeable trace.

For the touch-screen voting system, the major problems in voter intent representation focus on vote result confirmation, voting system security and public confidence. The touch-screen voting system stores all information electronically. The voter intent and vote result cannot be examined and confirmed by human eyes and hands. The security risk of touch-screen voting system is highly concentrated on a few technology experts. These technology experts can change vote result by electronic means without notice of ordinary citizens.

The second issue is voter accessibility. Voter accessibility here includes the aspects of the disabled voter accessibility, the aged voter accessibility, and multi-language accessibility.

For the mark-sense optical scan voting system, the major problems in voter accessibility focus on the disabled voter accessibility and multi-language accessibility. For blind voters and hand disabled voters, the ballots of the voting system cannot be finished by these voters directly. The number of non-English ballots for voters without enough English proficiency is hardly determined. Insufficient number of non-English ballots would cause participation difficulty for voters without enough English proficiency. Too much excessive number of non-English ballots would cause resource waste.

For the touch-screen voting system, the major problems in voter accessibility focus on the disabled voter accessibility and the aged voter accessibility. Blind voters and hand disabled voters can hardly use the touch-screen voting system to vote by themselves directly. Potentially, the touch-screen voting system can provide voice recognition devices. However, the environment of most polling places cannot protect the anonymousness and privacy of the disabled voters if they use voice recognition devices at the polling places. The touch-screen voting system needs each of voters to spend certain amount of time on a specific voting machine. The number of touch-screen voting machines is very limited at each of the polling places due to high purchase cost. When the demand for the use of the voting machine is above the serving capacity of the very limited touch-screen voting machine resource, a waiting line is accumulated. When the aged voters show up at a polling place in a large number, the measure of the aged voter priority cannot solve the problem of long waiting time of the aged voters. The long waiting line constrains the accessibility of the aged voters. The long waiting line also can make the aged voters feel unpleasant pressure due to the conflict of the long waiting line and the slow action of the aged voters.

The third issue is voter election day wait time. Voter election day wait time is the voter's total waiting time on election day at polling place to complete each step of the vote procedure.

For both the mark-sense optical voting system and the touch-screen voting system, each voter has to fill the ballot, either on paper ballot or on electronic screen, at the polling place. The time that voters have to spend to carefully read election issues and carefully select candidate for each election issue is much longer than that of voter identification verification. In another expression, in each serving procedure of the two voting systems above, the serving capacity of the second step is much less than the serving capacity of the first step. Therefore, when arriving number of voters per unit time at polling place is greater than a certain amount, the waiting line of voters will be accumulated longer and longer. Due to the high purchase cost of the touch-screen voting system, the number of the touch-screen voting machines at each polling place is usually very limited. Therefore, long voter election day wait time would occur more frequently and seriously for the touch-screen voting system.

The mark-sense optical scan voting system and the touch-screen voting system are the advanced voting systems at present. However, they still show above serious problems. The effort to resolve the above problems resulted in the following invention of a new ballot.

### SUMMARY OF THE INVENTION

The present invented voter individually specified and validation number sticker secured ballot and its making process are described as the following.

The ballot is made of two parts. The first part is a sheet of paper, on which voter individually specified, computer generated and electronically printed list of voter intent units for election issues is printed. The second part is a validation number sticker, on which a specific validation number that is generated by computer through a validation number coding method is printed. A valid ballot is made after and only after the validation number sticker is pasted on a specified place of the paper.

On the paper, which is the first part of the ballot, each of the voter intent units comprises:

(1) Election issue represented by whole set of letters of the election issue, such as President of the United States;

(2) One chosen candidate for the election issue represented by whole set of letters of the candidate, such as Abc Defg;

(3) Bar code solely representing the election issue and the one chosen candidate for the election issue.

The election issue can be a title of a position such as President of the United States. The election issue also can be a referendum. Associated with the election issue, only one candidate is shown on the paper. If candidates appear in the form of pair, one pair of candidates is called one candidate for the election issue in the present invention. For example, associated with the election issue of President of the United States, only the name of candidate Abc Defg is shown to be associated with President of the United States on the paper. In practice, candidates for Vice President of the United States are associated with candidates for President of the United States in election. One pair of candidates for President and Vice President of the United States is still called one candidate for the election issue in the present invention. The names of other candidates for the election issue are not shown on the paper. Associated with the election issue and the one chosen candidate for the election issue, an electronically printed bar code is shown on the paper. The electronically printed bar code is coded to solely represent the election issue and the one chosen candidate for the election issue. The combination of one election issue, one chosen candidate for the election issue and one bar code solely representing the election issue and the one chosen candidate for the election issue is called a voter intent unit in the present invention.

Because each voter intent unit only contains one candidate for one specific election issue that are represented by whole sets of electronically printed letters, any ambiguity of and any argument for voter intent will be eliminated. In the voter intent unit, the electronically printed bar code is coded by a coding method and is electronically printed for rapid and accurate machine count of the ballot. Due to the specific method of coding of the bar code, the arbitrary code length of the bar code, and electronically printed restrictive regular shapes of the bars of the bar code, the bar code makes extremely high machine count accuracy possible.

The paper is made with the following process steps:

(1) A computer software program is operated either on a site of a computer network or on an individual computer to show election issues and candidates for the election issues and allow voter to choose one of the candidates for each of the election issues;

(2) The voter uses computer to choose one candidate for each of the election issues;

(3) The computer software program associates a bar code with the election issue and the one chosen candidate and makes the bar code solely represent the election issue and the one chosen candidate;

(4) The step (2) and the step (3) are repeated until the election issues are completed;

(5) The voter uses the computer to print the list of the election issues, the candidates and the bar codes.

The validation number sticker, which is the second part of the ballot, is a sticker with an electronically printed validation number and an electronically printed bar code that represents the validation number. The validation number is generated through a specific validation number coding method. The validation number coding method provides management convenience and ballot security. The bar code that represents the validation number is to be scanned by optical scanner for rapid and accurate machine verification of the ballot validation.

A valid ballot is made after and only after the validation number sticker is pasted on the paper of the voter individually specified, computer generated and electronically printed list of voter intent units. The valid ballot can be scanned by optical scanner for rapid and accurate machine ballot count and also can be examined by human eyes and hands for confirmation and hand recount.

The procedure of the use of the ballot in election can be, but not limited to, as the following. Government operates computer software program on a site of computer network, such as Internet, or distributes computer software program to be used on individual computer to allow voters to generate and print the paper part of the ballot. The voter uses computer to choose one candidate for each election issue. If the voter does not select any one of the candidates of the election issue, some kind of expression, such as no intent, is shown on the paper. The expression of no intent here serves as a special kind of voter intent. After the voter chooses one candidate for a specific election issue, the computer software automatically associates a bar code with the election issue and the one chosen candidate for the election issue. The combination of an election issue, one chosen candidate for the election issue and the bar code representing the election issue and the one chosen candidate for the election issue forms a unit. The unit is called voter intent unit in the present invention. After the voter finishes the candidate selection procedure, the voter obtains a list of voter intent units. Printing the list of voter intent units, the voter obtains the paper part of the ballot. Government election officials use computer to generate a set of validation numbers through a specific validation number coding method and print each number of the set of the validation numbers on one sticker. On election day at polling places, election workers assign one validation number sticker to each voter during identification verification of the voter. The voter makes a valid ballot by pasting the validation number sticker on a specified place of the paper part of the ballot. The voter inserts the valid ballot into an optical scanner. The electronic device connected with the optical scanner records the voter intent.

The ballot has the following useful characteristics.

First, it has absolute voter intent certainty. The ballot only shows voter intent for each specific election issue. The ballot does not show any other non-chosen candidate for the specific election issue. If the voter does not choose any candidate for a specific election issue, such expression as no intent would be shown on the ballot. The ballot shows the voter intent for each specific election issue with electronically printed two whole sets of letters of the election issue and the one chosen candidate for the election issue. The ballot can be conveniently examined and confirmed by the voter. The voter can reconsider and amend the paper part of the ballot repeatedly in a sufficiently long time, which is measured in days or weeks. From both the aspect of validity of the ballot and the aspect of conscious selection from the voter, the ballot eliminates ambiguity of and argument for voter intent on the ballot.

Second, it has extremely high count accuracy. The ballot uses bar code that comprises a series of electronically printed bars to represent a specific election issue and one chosen candidate for the specific election issue. There is no limit on the length of the bar code so that the bar code can comprise sufficient number of bars to reduce bar code recognition error. Each bar code on the ballot can be scanned by an optical scanner repeatedly when the ballot moves forward in the set of optical scanner. The programmed long bar code can make the probability of bar code recognition error very close to zero.

Third, it can be examined and confirmed both by human eyes and by machines. The ballot shows the two whole sets of letters of the election issues and the one chosen candidate for the election issue. These letters can be examined and confirmed by human eyes.

Fourth, it is highly secured. The validation number sticker provides a restrictive control of the ballot security. The complete, electronically printed and individually specified list of the voter intent units on the ballot makes the ballot cannot be altered. Matching the record of distributed validation number stickers and the record of voting ballots can find which ballot is missing. Here, the record of voting ballots would not conflict with anonymousness by not recording assignment of which validation number sticker to which voter. The ballot examination and confirmation by human eyes can be performed randomly or completely. All these security features of the ballot form a comprehensive protection of the ballot and the vote result.

Fifth, it provides high accessibility to the aged and the disabled voters. When the aged voter uses computer to generate the ballot, the aged voter can choose enlarged letters to read more conveniently. The selection process of the aged voter generally is much slower than that of the younger voters. Using the ballot of the present invention, the aged voter can have practically unlimited time to carefully select candidates for election issues without worrying about the wait of other voters. The aged voters can avoid long wait time on election day at polling places because all voters finish the candidate selection process before voter identification verification. The aged and the disabled voters can use multi-media interactive input-output functions of computer to generate individually specified paper parts of the ballots at private places. Using the ballot of the present invention, the aged and the disabled voters need less help from election workers and therefore obtain more convenience and privacy.

Sixth, it conveniently and economically provides multi-language accessibility. Using the ballot of the present invention, voters can make use of multi-language capability of computer to generate individually specified ballots.

Seventh, it significantly decreases voter election day wait time. There are two factors here. The first factor is serving capacity for the event of voter election issue read and candidate selection and for the event of voter identification verification. Voters need certain amount of time to read election issues and select one candidate from a group of candidates for each election issue. Voters also need certain amount of time for voter identification verification. There is correspondent serving capacity for each of the two needed times. The second factor is serving sequential order of the above two events. For the first factor, using the ballot of the present invention, the serving capacity for the event of voter election issue read and candidate selection is practically unlimited due to utilizing the vast computer resource in society. Using the ballot of the present invention, voters are capable of utilizing large number of computers and printers at convenient places, such as home, school and library, to finish the paper part of the ballot in a period of time measured in days or weeks before the election day. On election day at polling place, if the voter does not carry the printed paper part of the ballot, the voter uses computer facility provided by government at polling place to finish the paper part of the ballot before voter identification verification. The polling places are usually located at public schools or public libraries, which usually possess sufficient number of computers and printers. Government election agencies are capable of directly providing sufficient number of computers and printers on election day at polling place because government possesses large computer resource. The utilization of vast computer resource is the first key for the ballot of the present invention to significantly reduce election day wait time. For the second factor, using the ballot of the present invention, the sequential order of the two events is optimized. For a voter, the time of election issue read and candidate selection is significant longer than the time of voter identification verification. When number of voters at polling place reaches a certain level, if the time of election issue read and candidate selection occurs after the time of voter identification verification, the significant difference in these two times causes voter waiting line at polling place. Using the ballot of present invention, the time of election issue read and candidate selection occurs before the time of voter identification verification. This switch of the sequential order of the two events significantly reduces the wait time. This optimized sequential order of the events is the second key for the ballot of the present invention to significantly reduce election day wait time.

### BRIEF DESCRIPTION OF THE DRAWINGS

FIG. 1 shows a paper part of a ballot.

FIG. 2 shows a valid ballot with a validation number sticker on it.

### DESCRIPTION OF THE PREFERRED EMBODIMENTS

A preferred embodiment of the present invention of the voter individually specified and validation number sticker secured ballot and its making process is described as the following.

A computer software program is operated either on a site of Internet or on an individual personal computer. The computer software program is programmed to allow the voter to choose one candidate for each of the election issues. The computer software program is also programmed to provide information of election precinct location and election date and prints the information on the paper part of the ballot. The voter uses computer and printer to make the voter individually specified, computer generated, and electronically printed paper part of the ballot.

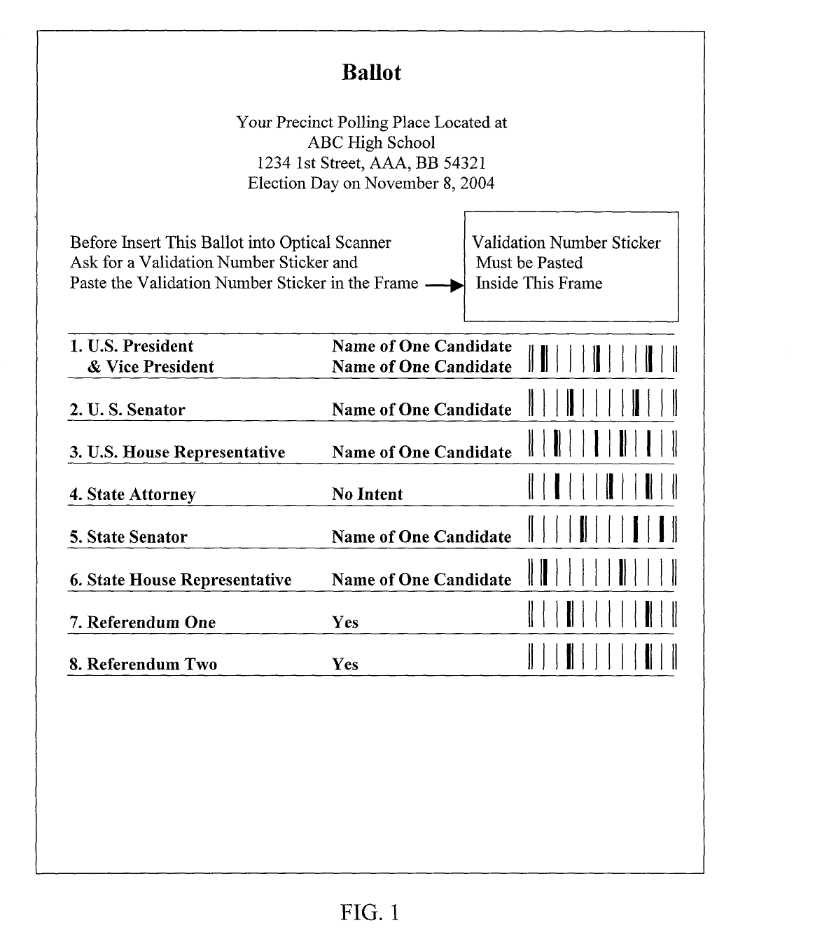

FIG. 1 shows one preferred form of the paper part of the ballot. At the head of the paper, election precinct location and election date are shown. The information of the election precinct location is shown by the computer software program based on the input of address of the voter. The information printed on the paper help the voter be at the right polling place on the election day. The information of the election date is shown by the computer software program to help the voter remember the election date. Below the information of the election precinct location and the election date, a frame is created to instruct the voter where to paste the validation number sticker. Below the validation number sticker frame, a list of voter intent units is printed. Each voter intent unit includes one election issue, one chosen candidate for the election issue, and bar code. The bar code is automatically associated with the election issue and the one chosen candidate for the election issue by the computer software program. The bar code solely represents the election issue and the one chosen candidate for the election issue and is to be scanned by optical scanner.

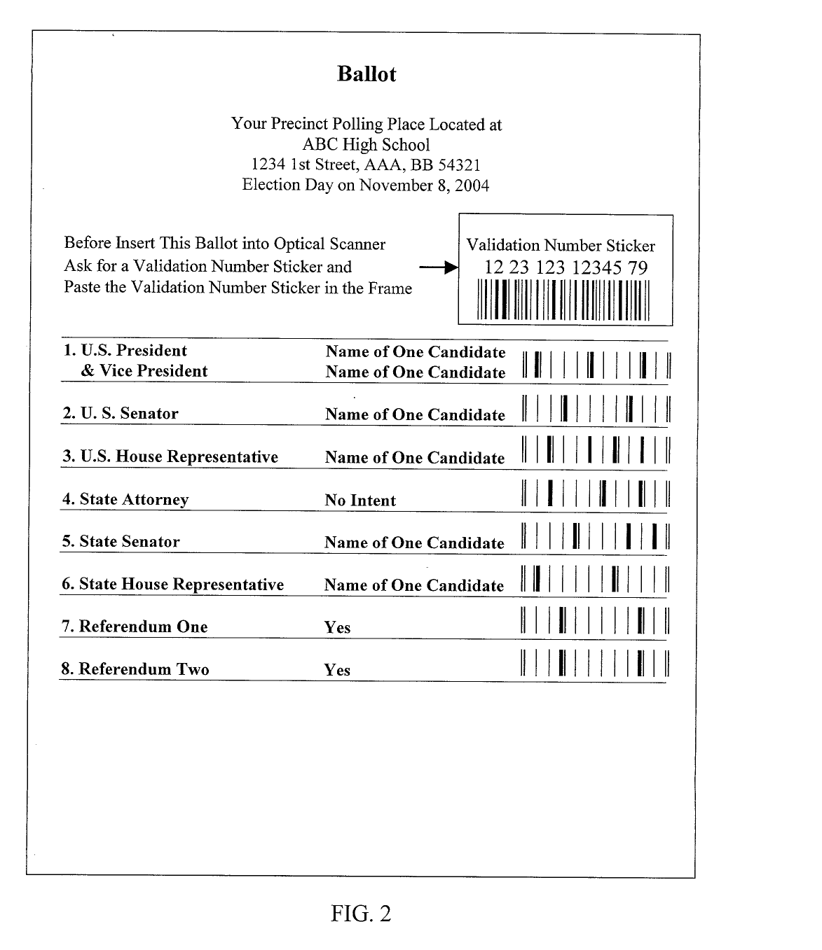

A computer software program is operated to generate a set of validation numbers. Each of the validation numbers is printed on a sticker. The sticker with the validation number is called validation number sticker. One part of FIG. 2 shows one validation number sticker that is pasted on the paper part of ballot. The validation number in the embodiment is divided into five parts. The first part 12 is a representation of one of the states of the country. The second part 23 is a representation of one of the counties of the state. The third part 123 is a representation of one of the precincts of the county. The fourth part 12345 is a representation of one number of a set of sequential numbers that cover the registered voters. Actually, these four parts of numbers form another set of sequential numbers. Each number in this set of sequential numbers provides useful information that can be conveniently checked by an examiner of the ballot. The number shows useful information about state, county, precinct and voter participation. The fifth part 79 is a two digit random number that associates with the other four parts. Each number of the set of sequential numbers that are formed by the former four parts of the validation number is associated with a two digit random number. The two digit random number makes the probability of passing ballot validation verification of a fraudulent validation number sticker equal to 0.01. This low probability provides strict security for the present invented ballot.

What is claimed is

1. A ballot combined by two separately made bodies, one of said two separately made bodies being a sheet of paper printed with voter individually specified, computer generated and electronically printed list of voter intent units and one of said two separately made bodies being an electronically printed validation number sticker, wherein
a) each one of said voter intent units comprising one election issue represented by whole set of letters of said election issue, one chosen candidate for said election issue represented by whole set of letters of said chosen candidate and one bar code solely representing said election issue and said chosen candidate;
b) said validation number sticker being a sticker printed with a validation number generated through a validation number coding method and printed with a bar code solely representing said validation number.

2. A making process of the ballot of claim 1, said making process comprising the steps of
a) a computer software program operated on a site of a computer network showing election issues and candidates and allowing only one of said candidates for each of said election issues to be chosen;
b) one of said election issues and one of said candidates being chosen through a computer connected with said site of a computer network;
c) said computer software program associating a bar code with said election issue and said chosen candidate, said bar code solely representing said election issue and said candidate;
d) a list being formed by repeating step (b) and step (c) until all election issues completed;
e) said list being printed electronically on a sheet of paper;
f) a computer software program generating a set of numbers through a validation number coding method and associating one bar code with each number of said set of numbers;
g) each number of said set of numbers and said associated bar code being printed on one sticker;
h) said sticker being pasted on a specified place of said paper in step (e).

3. A making process of the ballot of claim 1, said making process comprising the steps of
a) a computer software program operated on an individual computer showing election issues and candidates and allowing only one of said candidates for each of said election issues to be chosen;
b) one of said election issues and one of said candidates being chosen through said computer;
c) said computer software program associating a bar code with said election issue and said chosen candidate, said bar code solely representing said election issue and said candidate;
d) a list being formed by repeating step (b) and step (c) until all election issues completed;
e) said list being printed electronically on a sheet of paper;
f) a computer software program generating a set of numbers through a validation number coding method and associating one bar code with each number of said set of numbers;
g) each number of said set of numbers and said associated bar code being printed on one sticker;
h) said sticker being pasted on a specified place of said paper in step (e).

4. The ballot of claim 1, wherein said validation number coding method comprising the steps of
a) generating a set of sequential numbers;
b) associating each number of said set of sequential numbers with a random number.
